(19) United States
(12) Patent Application Publication
(10) Pub. No.: US 2010/0072228 A1
(43) Pub. Date: Mar. 25, 2010

(54) Decorative Liquid Soap Container (DLSC)

(76) Inventor: Lisa Spears, Florence, SC (US)

Correspondence Address: Lisa Spears, 856 Chaucer Drive, Florence, SC, 29505, US

(21) Appl. No.: 12/291,938

(22) Filed: Nov. 17, 2008

Related U.S. Application Data
(60) Provisional application No. 61/003,121, filed on Nov. 15, 2007.

(51) Int. Cl. B67D 7/06; B65D 88/54

(52) U.S. Cl. 222/183; 222/321.7

(57) ABSTRACT

The Decorative Liquid Soap Container (DLSC) is a decorative storage enclosure for disposable liquid soap/cleaning solution and hand sanitizer units. The disposable liquid soap or hand sanitizer unit fits inside of the Decorative Liquid Soap Container (DLSC) and a hole in the lid of the DLSC will fit over the pumping device of the disposable liquid soap or hand sanitizer unit. The DLSC could be designed to match items in any home/office/bathroom accessory set, such as a tissue box holder, cotton ball jar, pencil cup, trays, canisters, or trash can. Storing the disposable liquid soap, cleaning solution, or hand sanitizer unit inside the DLSC eliminates the need to manually pour solution into a dispenser. The DLSC can be mounted and it provides purposeful and decorative storage.

### CROSS-REFERENCE TO RELATED APPLICATIONS

This application claims priority of Provisional Application Number 61/003,121, filed Nov. 15, 2007.

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

The Decorative Liquid Soap Container (DLSC) is a home or office decorative enclosure for disposable liquid soap unit/cleaning solution/hand sanitizer units. It provides housing for these disposable units. The DLSC will allow its user to place any size disposable liquid soap or sanitizer unit inside of the storage container. The DLSC can be designed to match items in any bathroom accessory set such as a tissue box holder, cotton ball jar, and trash can. It may have a variety of colors, decorative or stylish elements. This invention eliminates time consuming and messy pouring of liquid soap into a dispenser by providing an easier, no pour method of coordinating liquid soap with bathroom accessory sets. It also provides a decorative container for housing hand sanitizer.

### BRIEF SUMMARY OF THE INVENTION

The Decorative Liquid Soap Container will allow its user to place any disposable liquid soap or hand sanitizer unit inside of a decorative storage container that can match a bathroom accessory set. This invention eliminates the need for pouring liquid soap into a decorative dispenser and provides decorative housing for hand sanitizer units. It also provides an easier, no pour method of coordinating liquid soap with bathroom accessories and a means of having hand sanitizer units displayed in a visually pleasing manner.

### BRIEF DESCRIPTION OF THE SEVERAL VIEWS OF THE DRAWING

FIG. 1—Front Page view of DLSC with lid detached and positioned over it.

FIG. 1A—Front view of DLSC with lid detached and positioned over it.

FIG. 2—Top view of the lid while it is detached from the DLSC.

FIG. 3—Three dimensional side view of DLSC with lid hovering over it.

FIG. 4—Front view of DLSC with disposable liquid soap/sanitizer pumping unit displayed through the lid.

FIG. 5—Rear view of DLSC with mounting holes.

### DESCRIPTION OF THE PREFERRED EMBODIMENT

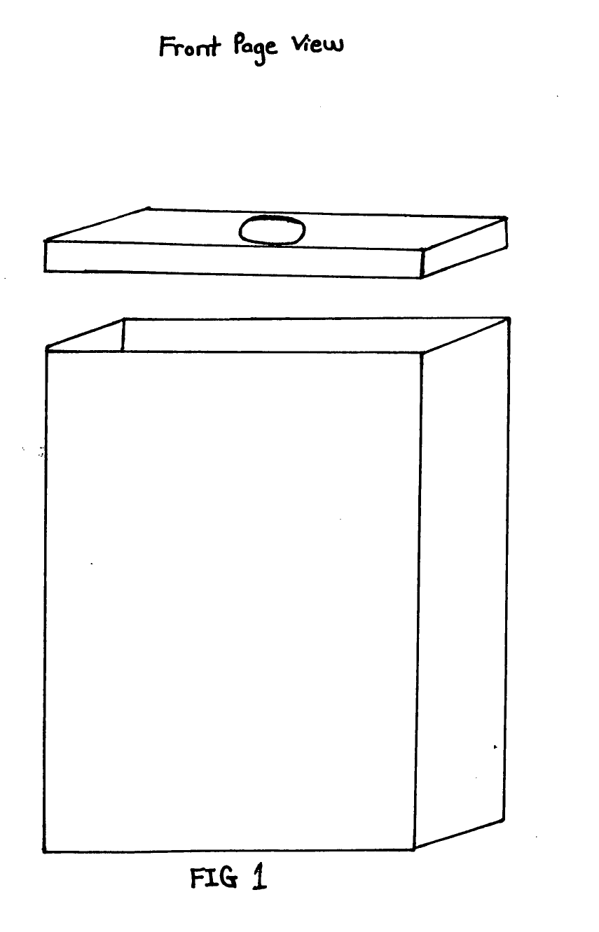

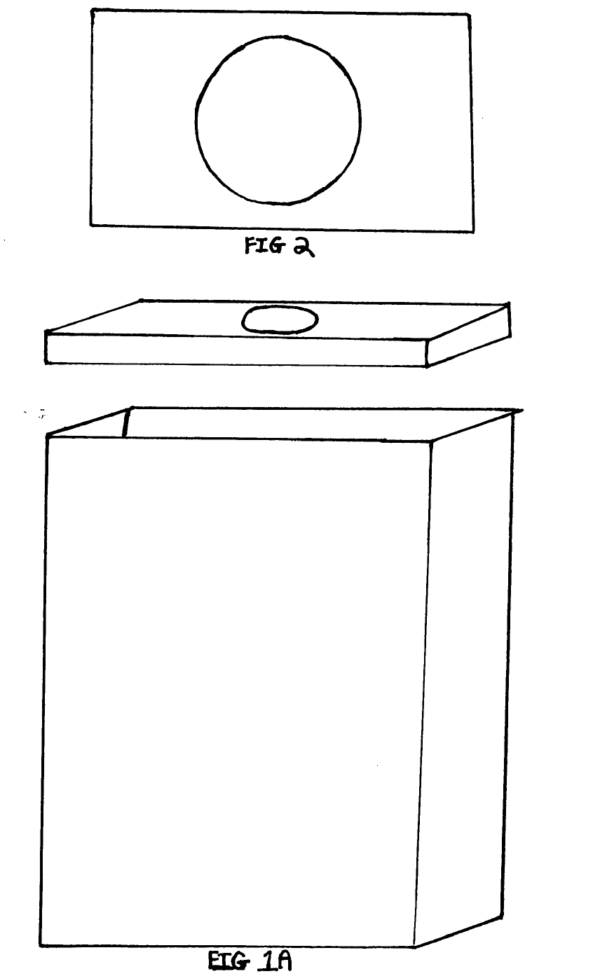

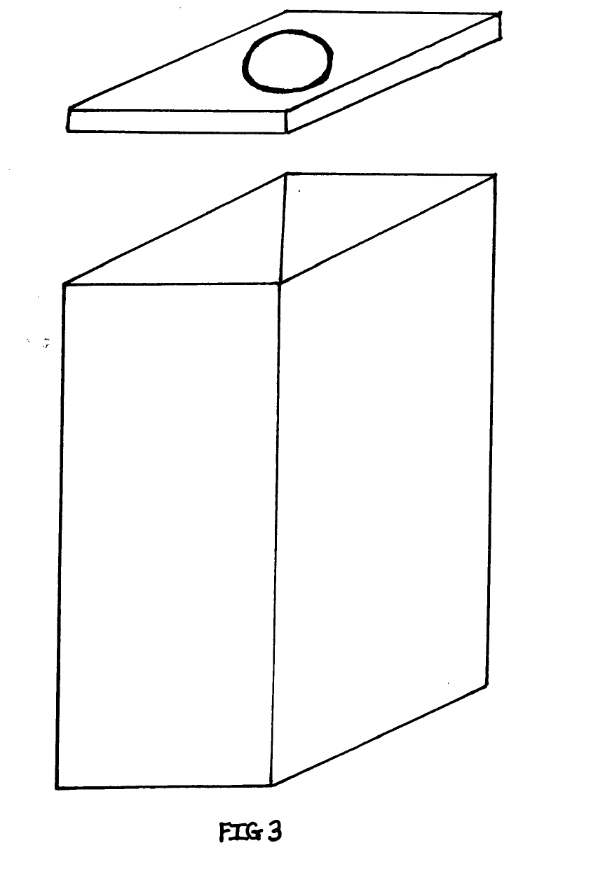

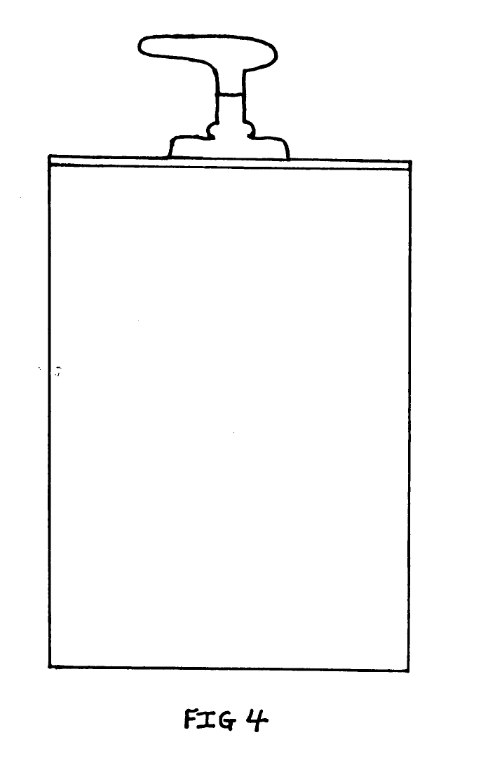

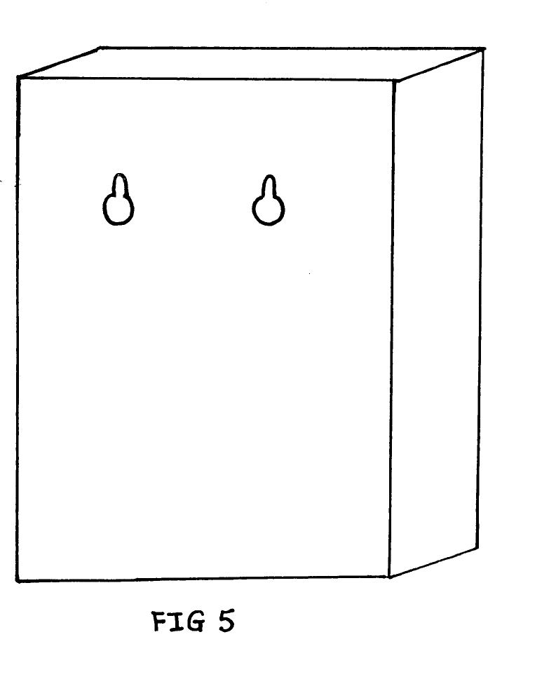

Referring to FIGS. 1-4, a Decorative Liquid Soap Dispenser (DSLC) in accordance with a first preferred embodiment of the invention shown. This invention is a purposeful and decorative storage container for liquid soap/cleaning solution dispensers and hand sanitizer units. It is used by placing the disposable liquid soap/cleaning solution or hand sanitizer unit inside of the DLSC (FIG. 1, 1A, 3) and placing the hole in the lid over the top of the disposable units pump (FIG. 2). The user will pump soap, cleaning solution, or hand sanitizer using the disposable unit that is housed in the DLSC (FIG. 4). The DLSC may have holes on the back side so that it may be mounted to the wall (FIG. 5).

The best mode for making the DLSC is dependent upon whether it matches a bathroom/office/home accessory set or not. Material for making it could include but are not limited to: resin, chrome, glass, onyx, stone, ceramic, wood, and metals such as brass, silver, and steel. The most popular mode for making this invention could be injection molding due to the high utilization of resin in bathroom/home/office accessories. This mode better lends itself to mass production.

The injection molding process utilizes resin, usually in pellet or granule form. Resin is fed to the injection molding machine through a hopper. Colorants are usually fed to the machine directly after the hopper. The resins enter the injection barrel by gravity through the feed throat. Upon entrance into the barrel, the resin is heated to the appropriate melting temperature and then injected into the mold. After the injection process, the mold is then closed shut and the heated material solidifies. The process is completed when the mold opens and the new shape is ejected.

1. The DLSC houses any liquid soap or cleaning solution unit and eliminates the need to pour the solution into a dispenser.
A disposable liquid soap or cleaning solution unit is placed inside of the DLSC. The removable lid is placed on top of the unit.
The pump of the unit is displayed through the hole that is in the container's removable lid.

2. The device of claim 1 provides purposeful storage for disposable liquid soap or cleaning solution units.

3. The device of claim 1 could have its own decorative scheme or match a brand's office/home/bathroom accessory set and could be made from a variety of materials.

4. The device of claim 1 uses the pump of the disposable liquid soap or cleaning solution unit once it is placed inside of the DLSC.

5. The DLSC houses hand sanitizer units.
A hand sanitizer unit is placed inside of the DLSC.
The removable lid is placed on top of the unit.
The pump of the unit is displayed through the hole that is in the container's removable lid.

6. The device of claim 5 provides purposeful storage for hand sanitizer.

7. The device of claim 5 could have its own decorative scheme or match a brand's office/home/bathroom accessory set and could be made from a variety of materials.

8. The device of claim 5 uses the pump of the hand sanitizer unit once it is placed inside of the DLSC.

9. The Disposable Liquid Soap Dispenser has the option of being mounted to a wall.
The DSLC may have screw holes that will allow the DSLC to be mounted.
The liquid soap/cleaning solution/hand sanitizer unit can then be placed in the mounted DSLC.
